(19) United States
(12) Patent Application Publication
(10) Pub. No.: US 2013/0302560 A1
(43) Pub. Date: Nov. 14, 2013

(54) GLASS SUBSTRATE STACKING STRUCTURE, DEVICE AND METHOD FOR FILM COATING PROCESS

(71) Applicants: Yung-chien Chen, Guanyin Township (TW); Che-Cheng Kuo, Zhongli City (TW); Yen-yu Huang, Bade City (TW); Tzu-pin Lin, Tainan City (TW)

(72) Inventors: Yung-chien Chen, Guanyin Township (TW); Che-Cheng Kuo, Zhongli City (TW); Yen-yu Huang, Bade City (TW); Tzu-pin Lin, Tainan City (TW)

(73) Assignee: CHUNGHWA PICTURE TUBES, LTD.

(21) Appl. No.: 13/570,269

(22) Filed: Aug. 9, 2012

(30) Foreign Application Priority Data
May 14, 2012 (TW) 101117072

(51) Int. Cl. B32B 3/10; B65G 57/02; B32B 17/06

(52) U.S. Cl. 428/138; 414/802

(57) ABSTRACT

The present invention provides a glass substrate stacking structure, a glass substrate stacking device, and a method for forming the glass substrate stacking structure, which are particularly suitable for a film coating process to a glass substrate of a TFT-LCD panel. The glass substrate stacking structure includes a first glass substrate and a second glass substrate. The second glass substrate is disposed under the first glass substrate and has air holes. By pumping and blowing air through the air holes, the first glass substrate and the second glass substrate can be adhered to and separated from each other. The present invention also provides a method and a device for stacking the glass substrate stacking structure mentioned above.

### BACKGROUND OF THE INVENTION

1. Field of the Invention

The present invention provides a glass substrate stacking structure, a glass substrate stacking device, and a method for stacking the glass substrates, more, particularly, to a glass substrate stacking structure having air holes, a glass substrate stacking device, and a method for stacking the glass substrates.

2. Description of the Prior Art

It easily has trouble in processing a glass substrate of a Liquid Crystal Display (LCD) or a touch panel because of its thin thickness. Therefore, its difficult to coat film on a thin glass substrate to form Thin Film Transistors (TFTs).

In a general film coating process, it uses a mechanical arm to move a glass substrate into and from an equipment. However, thin and large-size glass substrates are fragile during moving. Such being the case, it is necessary to have a solution for simple manipulation and easy processing.

### SUMMARY OF THE INVENTION

The object of the present invention is to provide a glass substrate stacking structure to solve the problem of breaking the glass substrate in a film coating process.

In one aspect of the present invention, a glass substrate stacking structure for a film coating process comprises a first glass substrate having a first surface and a second surface, and a second glass substrate having a third surface and a fourth surface and bracing the first glass substrate. A thin film transistor process is formed on the first surface of the first glass substrate by using the PVD (physical vapor deposition) or CVD (chemical vapor deposition) process, and the first glass substrate is used as a substrate for process. The fourth surface of the second glass substrate comprises at least a first group of air holes going through to the third surface for pumping and blowing air, the second surface of the first glass substrate adheres to the third surface of the second glass substrate when pumping air from the first group of air boles, and the second surface of the first glass substrate is separated from the third surface of the second glass substrate when blowing air from the first group of air holes.

In another aspect of the present invention, a glass substrate stacking device for a film coating process comprises: a mechanical platform having a upper surface and a lower surface; a first group of airways comprising a plurality of airways formed on the upper surface of the mechanical platform, and each of the first group of airways connects with each other; a second group of airways comprising a plurality of airways formed on the upper surface of the mechanical platform, and each of the second group of airways connects with each other; a second group of air holes comprising a plurality of air holes, connecting with the first group of airways formed on the upper surface of the mechanical platform and go through to the lower surface of the mechanical platform so that it is capable of pumping and stopping pumping air from the first group of airways through the second group of air holes; a third group of air holes comprising a plurality of air holes, connecting with the second group of airways formed on the upper surface and going through the lower surface so that it is capable of pumping, stopping pumping and blowing air from the second group of airways through the third group of air holes, wherein the first group of airways is separate from the second group of airways.

The glass substrate stacking structure is disposed on the glass substrate stacking device. The glass substrate stacking device comprises a third group of air holes of mechanical platform connecting to the third surface of the second glass substrate through the second group of airways and the first group of air holes of the second glass substrate.

In still another aspect of the present invention, a method of stacking a first glass substrate and a second glass substrate on a mechanical platform used in a film coating process is provided. The second glass substrate has a first group of air holes going through the second glass substrate. The mechanical platform has a second group of air holes, a third group of air holes, a first group of airways and a second group of airways. Each of the first group of airways forms on the upper surface of the mechanical platform and connects with each other. Each of the second group of airways forms on the upper surface of the mechanical platform and connects with each other. The second group of air holes connects with the first group of airways on the upper surface of the mechanical platform and goes through to the lower surface of the mechanical platform. The third group of air holes connects with the second group of airways on the upper surface of the mechanical platform and goes through to the lower surface of the mechanical platform. The first group of airways is separated from the second group of airways. The method comprises: putting the second glass substrate on the mechanical platform, pumping air from the second group of air holes for the second glass substrate adhering to the mechanical platform; stacking the first glass substrate on the second glass substrate; and pumping air from the third group of air holes through the second group of airways and the first group of air holes of the second glass substrate for the first glass substrate adhering to the second glass substrate. In order to separate the first glass substrate from the second glass substrate, blowing air from the third group of air holes through the second group of airways and the first group of air holes of the second glass substrate makes the first glass substrate in air floating state.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a glass substrate stacking structure for a film coating process according to a preferred embodiment of the present invention.

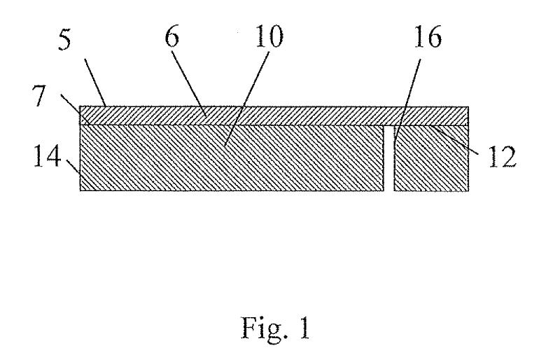

FIG. 2 shows a glass substrate stacking device for a film coating process according to an embodiment of the present invention.

FIG. 3 illustrates a top view of the second glass substrate of the glass substrate stacking structure for a film coating process according to the present invention.

FIG. 4 illustrates a top view that the glass substrate stacking structure is disposed in a glass substrate stacking device for a film coating process according to a preferred embodiment of the present invention.

FIG. 5 shows a mechanical platform.

FIG. 6 shows a glass substrate stacking device for a film coating process according to another embodiment of the present invention.

### DETAILED DESCRIPTION OF THE PREFERRED EMBODIMENTS

Hereinafter, preferred embodiments of the present invention will be described in detail with reference to the accompanying drawings. It is to be noted that the same reference numerals are used to designate the same elements throughout the specification. In addition, detailed descriptions of known functions and configurations incorporated herein is omitted to avoid making the subject matter of the present invention unclear.

Referring to Fig. I showing a glass substrate stacking structure for a film coating process according to a preferred embodiment of the present invention, the glass substrate stacking structure comprises a first glass substrate 6 and a second glass substrate 10.

The first glass substrate 6 has a first surface 5 and a second surface 7. The first surface 5 is used for operating a film coating process of PVD and CVD process to form TFT process, and the first glass substrate 6 is used as a substrate of TFT process. The first glass substrate is easily broken because the thickness of the first glass substrate 6 used for a TFT process of LCD is less than 0.15 mm according to the latest technique, and therefore it is quite difficult to coat film on the first surface 5 of the first glass substrate 6 directly by using the PVD or CVD process. The embodiment provides a thicker glass substrate (that is a second glass substrate 10) disposed under the first glass substrate 6 for bracing the first glass substrate 6 to coat film on the first surface 5 of the first glass substrate 6 by using the PVD or CVD process.

The thickness of the second glass substrate 10 is generally equal or larger than 0.35 mm, and the thickness in the embodiment is 0.5 mm. The second glass substrate 10 has a third surface 12 and a fourth surface 14. The fourth surface 14 of the second glass substrate 10 opens at least a first group of air holes 16 through the second glass substrate 10 to the third surface 12. By pumping or blowing air through the first group of air holes 16, the first glass substrate 6 and the second glass substrate 10 can be adhered to and separated from each other.

The first group of air holes 16 in the embodiment comprises a plurality of air holes going through the second glass substrate 10 from the fourth surface 14 to the third surface 12 and distributed at equal intervals on the fourth surface 14 of the second glass substrate 10. The appropriate interval of the first group of air holes 16 is between 3 cm and 5 cm.

By pumping air through the first group of air holes 16, air between the second surface 7 of the first glass substrate 6 and the third surface 12 of the second glass substrate 10 is pumping out, and it leads to a vacuum between the first glass substrate 6 and second glass substrate 10. Therefore, the second surface 7 of the first glass substrate 6 adheres to the third surface 12 of the second glass substrate 10. On the contrary, the second surface 7 of the first glass substrate 6 separates from the third surface 12 of the second glass substrate 10 because of air pressure when air is blown into space between the second surface 7 of the first glass substrate 7 and the third surface 12 of the second glass substrate 10 through the first group of air holes 16.

The second glass substrate 10 is appropriate to being drilled by an irradiation, such as Ultraviolet laser, not by mechanics, to destruct glass bonding to form the first group of air holes 16 because the material of the second glass substrate 10 is glass.

The first glass substrate 6 is generally a giant panel whose area is 680 mm×880 mm. In order for the second surface 7 of the first glass substrate 6 and the third surface 12 of the second glass substrate 10 being adhered to or separated from each other evenly, the present invention provides another device for stacking the first glass substrate 6 and the second glass substrate 10.

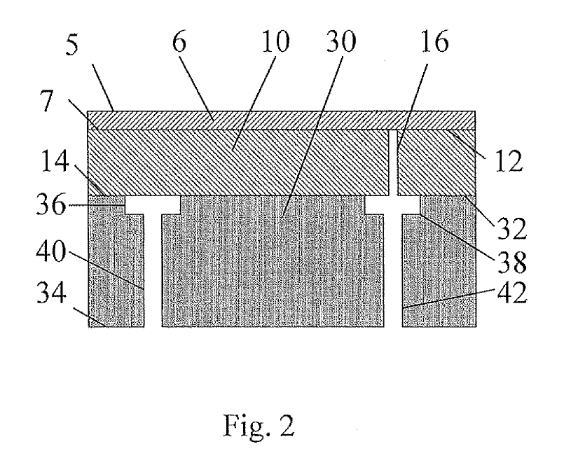

Please refer to FIG. 2. FIG. 2 shows a glass substrate stacking device for a film coating process according to an embodiment of the present invention. The device comprises a mechanical platform 30 having an upper surface 32 and a lower surface 34. The first glass substrate 6 and the second glass substrate 10 are disposed on the upper surface 32 of the mechanical platform 30.

The mechanical platform 30 comprises a first group of airways 36. The first group of airways 36 comprises a plurality of airways formed on the upper surface 32 of the mechanical platform 30, and the airways connect with each other. In addition, the mechanical platform 30 comprises a second group of airways 38. The second group of airways 38 comprises a plurality of airways formed on the upper surface 32 of the mechanical platform 30. The second group of airways 38 connects with each other but not with the first group airways 36. That is, the first group of airways 36 is separated from the second group of airways 38. The arrangement of the airways is illustrated in the following paragraphs.

The mechanical platform 30 further comprises a second group of air holes 40 and a third group of air holes 42. The second group of air holes 40 comprises a plurality of air holes connecting with the first group of airways 36 formed on the upper surface 32 of the mechanical platform 30 and going through to the lower surface 34 of the mechanical platform 30. The third air holes 42 comprises a plurality of air holes connecting with the second group of airways 38 in the upper surface 32 and going through to the lower surface 34 of the mechanical platform 30.

The first group of airways 36 and the second group of airways 38 have a plurality of rows. The rows of the first group of airways 36 and those of the second group of airways 38 arrange alternately in the upper surface 32 of the mechanical platform 30.

The preferred material of the mechanical platform 30 is usually aluminum, iron or their alloys because of the necessity of machining (e.g. milling) the first group of airways 36 and the second group of airways 38 are on the upper surface 32 of the mechanical platform 30 and the strength requirement for bracing the first glass substrate 6 and the second substrate 10 on the upper surface 32.

The second group of air holes 40 of the mechanical platform 30 connects with the first group of airways 36, and the third group of air holes 42 of the mechanical platform 30 connects with the second group of airways 38 as mentioned above. It is capable of pumping and stopping pumping air from the first group of airways 36 through the second group of air holes 40 according to the embodiment in the present invention. In addition, it is capable of blowing, pumping and stopping pumping air from the second group of airways 38 through the third group of air holes 42 of the mechanical platform 30.

The second group of air holes 40 goes through the mechanical platform 30 from the lower surface 34 of the mechanical platform 30 and connects with the first group of airways 36 in the upper surface 32 of the mechanical platform 30. The third group of air holes 42 goes through the mechanical platform 30 from the lower surface 34 of the mechanical platform 30 and connects with the second group of airways 38 in the upper surface 32 of the mechanical platform 30. Each of the second group of air holes 40 and the third group of air holes 42 has a plurality of air holes arranged in linear array in the lower surface 34 of the mechanical platform 30. For instance, the second group of air holes 40 arranges linearly in a row, and the third group of the air holes 42 goes in another row. The two rows arranges in the lower surface 34 of the mechanical platform 30 in parallel. The preferred distance between the air holes is 3 cm to 5 cm.

The first glass substrate 6 and the second glass substrate 10 are stacked on the upper surface 32 of the mechanical platform 30 in order, and the second glass substrate 10 is under the first glass substrate 6. The structure of the first glass substrate 6 and the second glass substrate 10 have been demonstrated above, and therefore repeated description is omitted.

The fourth surface 14 of the second glass substrate 10 is disposed on the upper surface 32 of the mechanical platform 30, and the second surface 7 of the first glass substrate 6 is disposed on the third surface 12 of the second glass substrate 10.

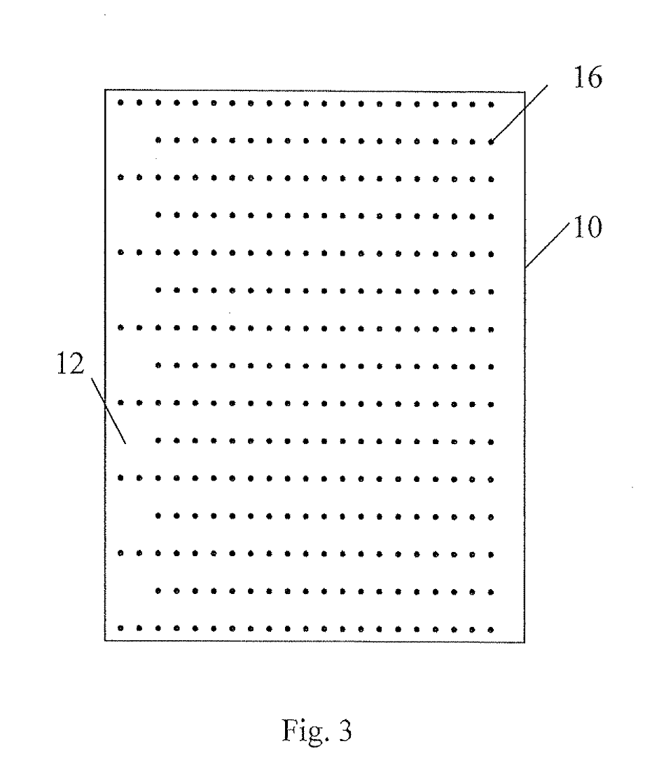

A plurality of holes of the first group of air holes 16 in the second glass substrate 10 are arranged along with and aimed at the second group of airways 38 of the mechanical platform 30. Equally-spaced configuration for the plurality of holes is preferred. FIG. 3 illustrates a top view of the second glass substrate of the glass substrate stacking structure for a film coating process according to the present invention. FIG. 3 shows distribution of the first group of air holes 16.

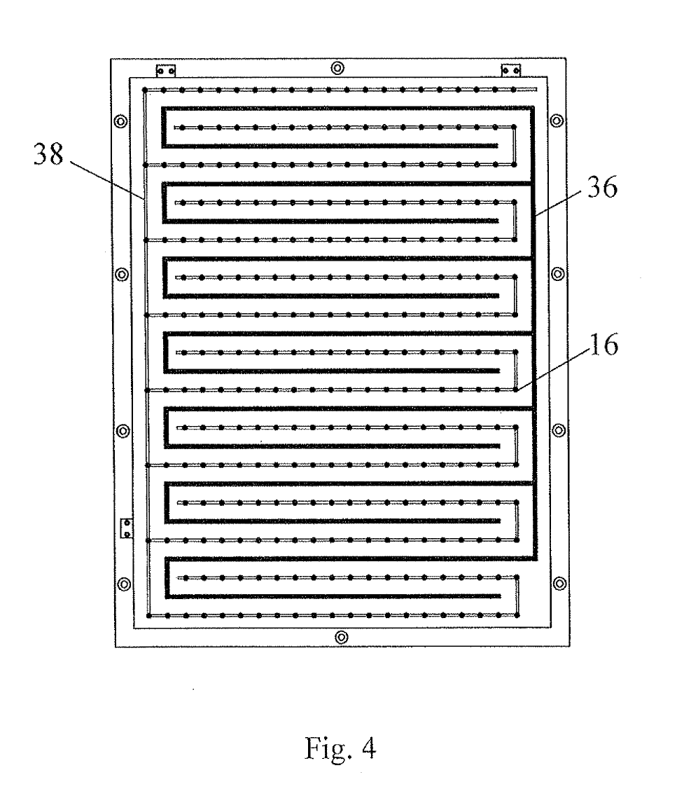

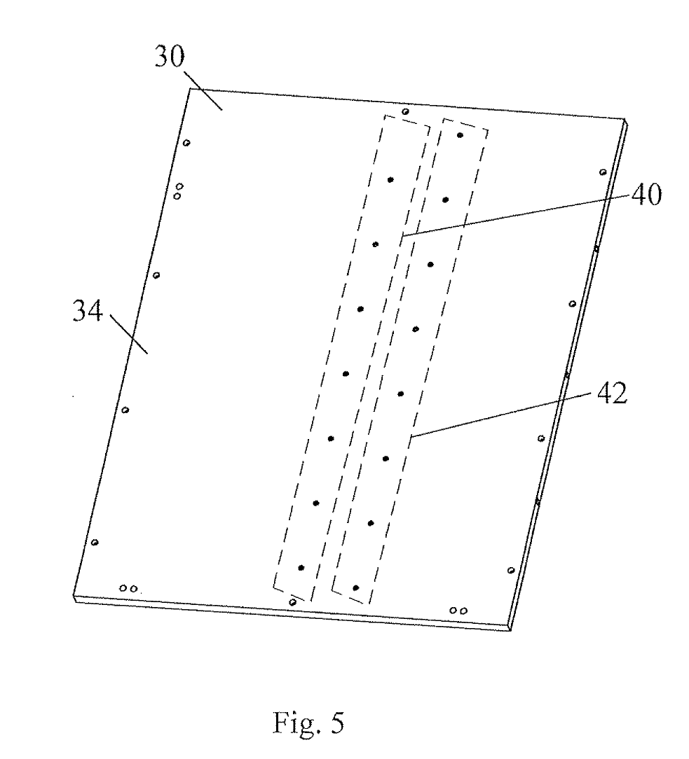

Refer to FIG. 4 and FIG. 5. FIG. 4 illustrates a top view that the glass substrate stacking structure is disposed in a glass substrate stacking device for a film coating process according to a preferred embodiment of the present invention. FIG. 5 shows the mechanical platform 30. It can be observed that the first group of airways 36 and the second group of airways 38 are arranged in rows respectively, because the material of the first glass substrate 6 and the second glass substrate 10 is transparent glass. The rows of the first group of airways 36 and the second group of airways 38 arranges alternately in the upper surface of the mechanical platform. Airways in the same group connect with each other, but the first group of airways 36 is separated from the second group of airways 38. A plurality of holes of the first group of air holes 16 on the second glass substrate 10 are arranged along with and aimed at the second group of airways 38 of the mechanical platform 30. The plurality of air holes are equally spaced, and the preferred distance of is 3 cm to 5 cm.

In manipulation, it uses a high pressure air vacuum converter and a throttle valve to control. the second group of air holes 40 pumping air through the first group of airways 36 for the second glass substrate 10 being adhered to the mechanical platform 30. The fourth surface 14 of the second glass substrate 10 is adhered to the upper surface 32 of the mechanical platform 30 firmly while pumping air out of the first group of airways 36 through the second group of air holes 40. And the glass substrate can be removed from. the mechanical platform 30 after pumping air out of the first group of airways 36 through the second group of air holes 40 is stopped.

It is also capable of using a high pressure air vacuum converter and a throttle valve to control the third group of air holes 42 to pump, stop pumping and blow air through the second group of airways 38. The third surface 12 of the second glass substrate 10 is adhered to the second surface 7 of the first glass substrate 6 after pumping air out of the second group of airways 38 through the third group of air holes 42. Space between the second surface 7 of the first glass substrate 6 and the third surface 12 of the second glass substrate 10 is going to be filled with air through the first group of air holes 16 after blowing air to the second group of airways 38 through the third group of air holes 42, and the two glass substrates separate.

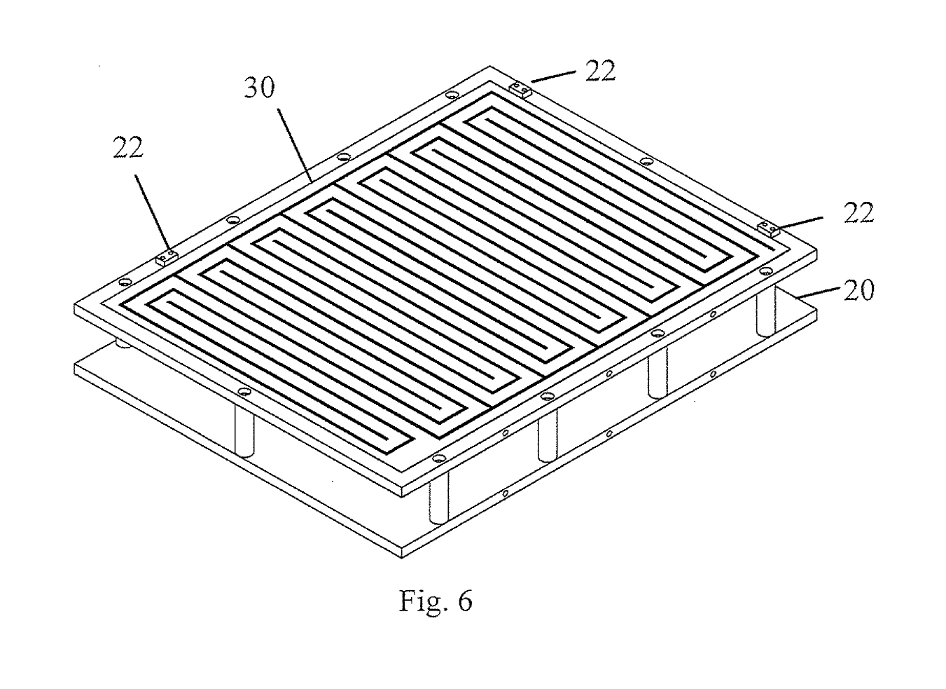

Referring to FIG. 6 showing a glass substrate stacking device for a film coating process according to another embodiment of the present invention, the first glass substrate 6 and the second glass substrate 10 are stacked on the device. Besides the mechanical platform 30 mentioned above, the device in the embodiment further comprises a supporting platform 20 for supporting the mechanical platform 30 and a positioning block 22 on the mechanical platform 30 for positioning the first glass substrate 6 and the second glass substrate 10.

The method of stacking glass substrates for a film coating process according to the present invention comprises following steps:
(a) putting the second glass substrate 10 on the mechanical platform 30 and pumping air through the second group of air holes on the mechanical platform 30, thereby adhering the second glass substrate 10 to the mechanical platform 30;
(b) stacking the first glass substrate 6 on the second glass substrate 10;
(c) pumping air filled between the second glass substrate 10 and the first glass substrate 6 out from the third group of air holes 42 in the mechanical platform 30 through the second group of airways 38 on the mechanical platform 30 and the first group of air holes 16 on the second glass substrate 10 for adhering the first glass substrate 6 to the second glass substrate 10.

It leads to a glass substrate stacking structure that the first glass substrate 6 firmly adheres to the second glass substrate 10 according to the above manipulating process. Therefore, the first glass substrate 6 still firmly adheres to the second glass substrate 10 even though all pumping manipulations has stopped and the glass substrate stacking structure has been taken down from the mechanical platform 30. For instance, when it requires the first glass substrate 6 to be processed elsewhere, such as removing the first glass substrate 6 to a film coating chamber for a film coating process, a glass substrate stacking structure, formed by the first glass substrate 6 and the second glass substrate 10, is removed from the mechanical platform 30, and the whole glass substrate stacking structure (that is, the first glass substrate 6 and the second substrate 10 as a whole) is removed to the chamber for the film coating process by the method. And then, the glass substrate stacking structure is taken out after the film coating process for the first glass substrate 6 is finished.

The thickness of the second glass substrate 10 is greater than that of the first glass substrate 6 because it is necessary for the second glass substrate 10 to provide adequate rigidity. In one embodiment, the thickness of the first glass substrate 6 is 0.05 mm, and that of the second glass substrate 10 is 0.5 mm. in another embodiment, the thickness of the first glass substrate 6 is 0.1 mm, and that of the second glass substrate 10 is 0.4 mm. Other appropriate thickness is acceptable as well. Preferably, the thickness of the second glass substrate 10 is four or more times than that of the first glass substrate.

When it is going to separate the first glass substrate 6 from the second glass substrate 10 of the glass substrate stacking structure, the operating process is:
(d) putting the glass substrate stacking structure on the mechanical platform 30, blowing air from the third group of air holes 42 in the mechanical platform 30 to space between the first glass substrate 6 and the second glass substrate 10 through the second group of airways 38 in the mechanical platform 30 and the first group of air holes 16 in the second glass substrate 10 to make the first glass substrate 6 in air floating state to separate the first glass substrate 6 from the second glass substrate 10.

In conclusion, the present invention provides a glass substrate stacking structure, a method for stacking the glass substrates and a glass substrate stacking device so that ultra thin glasses are not broken by thermal deformation or stress deformation, etc. or during removing in and out of the device. In the meanwhile, the glass substrate stacking structure makes transportation of glass substrates more convenient and easy, and thereby reduces labor and material costs and raises yield.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A glass substrate stacking structure for a film coating process comprising:
a first glass substrate having a first surface and a second surface;
a second glass substrate having a third surface and a fourth surface and bracing the first glass substrate,
wherein at least a first group of air holes formed on the fourth surface of the second glass substrate goes through to the third surface for pumping and blowing air, the second surface of the first glass substrate adheres to the third surface of the second glass substrate when pumping air from the first group of air holes, and the second surface of the first glass substrate is separated from the third surface of the second glass substrate when blowing air from the first group of air holes.

2. The glass substrate stacking structure for a film coating process of claim 1, wherein the first group of air holes comprises a plurality of holes distributed at equal intervals on the fourth surface of the second glass substrate.

3. The glass substrate stacking structure of claim 1, wherein the thickness of the first glass substrate is equal to or lower than 0.15 mm, and that of the second glass substrate is equal to or larger than 0.35 mm.

4. The glass substrate stacking structure for a film coating process of claim 3, wherein the thickness of the second glass substrate is four or more times than that of the first glass substrate.

5. The glass substrate stacking structure for a film coating process of claim 1, wherein a thin film transistor process is formed on the first surface of the first glass substrate, and the first glass substrate is used as a substrate for process.

6. The glass substrate stacking structure for a film coating process of claim 1, wherein the first group of air holes in the second glass substrate are formed by destructing glass bonding by ultraviolet laser.

7. A glass substrate stacking device for a film coating process comprising:
a mechanical platform having a upper surface and a lower surface;
a first group of airways comprising a plurality of airways formed on the upper surface of the mechanical platform, and each of the first group of airways connects with each other;
a second group of airways comprising a plurality of airways formed on the upper surface of the mechanical platform, and each of the second group of airways connects with each other;
a second group of air holes comprising a plurality of air holes, connecting with the first group of airways formed on the upper surface of the mechanical platform and going through to the lower surface of the mechanical platform so that it is capable of pumping and stopping pumping air from the first group of airways through the second group of air holes;
a third group of air holes comprising a plurality of air holes, connecting with the second group of airways formed on the upper surface and going through the lower surface so that it is capable of pumping, stopping pumping and blowing air from the second group of airways through the third group of air holes, wherein the first group of airways is separated from the second group of airways.

8. The glass substrate stacking device for a film coating process of claim 7, wherein the first group of airways and the second group of airways have a plurality of rows, and the rows of the first group of airways and those of the second group of airways are arranged alternately in the upper surface of the mechanical platform.

9. The glass substrate stacking device for a film coating process of claim 7, wherein the material of the mechanical platform is aluminum, iron or their alloys.

10. The glass substrate stacking device for a film coating process of claim 7, wherein each of the second group of air holes and the third group of air holes has a plurality of air holes arranged in linear array in the lower surface of the mechanical platform.

11. The glass substrate stacking device for a film coating process of claim 7, wherein a first glass substrate and a second glass substrate which is disposed under the first glass substrate stack on the upper surface of the mechanical platform when the device is in use, the first glass substrate has a first surface and a second surface, the second glass substrate has a third surface and a fourth surface, and at least a first group of air holes is defined on the fourth surface of the second glass substrate and goes through the second glass surface to the third surface.

12. The glass substrate stacking device for a film coating process of claim 11, wherein the third group of air holes of mechanical platform connects with the third surface of the second glass substrate through the second group of airways and the first group of air holes of the second glass substrate.

13. A method for stacking glass substrates used in a film coating process for stacking a first glass substrate and a second glass substrate on a mechanical platform, the second glass substrate comprising a first group of air holes going through the second glass substrate, the mechanical platform comprising a second group of air holes, a third group of air holes, a first group of airways and a second group of airways, each of the first group of airways forming on the upper surface of the mechanical platform and connecting with each other, each of the second group of airways forming on the upper surface of the mechanical platform and connecting with each other, the second group of air holes connecting with the first group of airways in the upper surface of the mechanical platform and going through to the lower surface of the mechanical platform, the third group of air holes connecting with the second group of airways on the upper surface of the mechanical platform and going through to the lower surface of the mechanical platform, the first group of airways separating from the second group of airways, the method comprising:
putting the second glass substrate on the mechanical platform, pumping air from the second group of air holes for the second glass substrate adhering to the mechanical platform;
stacking the first glass substrate on the second glass substrate; and
pumping air from the third group of air holes through the second group of airways and the first group of air holes of the second glass substrate for the first glass substrate adhering to the second glass substrate.

14. A glass substrate stacking method for a film coating process of claim 13, further comprising:
blowing air from the third group of air holes through the second group of airways and the first group of air holes of the second glass substrate to make the first glass substrate in air floating state to separate the first glass substrate from the second glass substrate.)
